(19) United States
(12) Patent Application Publication
(10) Pub. No.: US 2005/0003216 A1
(43) Pub. Date: Jan. 6, 2005

(54) Microparticle containing silicone release coatings having improved anti-block and release properties

(76) Inventors: Jean-Marc Frances, Meyzieu (FR); Michael D. Radl, Rock Hill, SC (US); Stuart R. Kerr III, Charlotte, NC (US); Jeffrey Hoover, Rock Hill, SC (US); James G. Ellison, Chester, SC (US)

Correspondence Address: MIALEEKA WILLIAMS;RHODIA INC., CN 7500, CRANBURY, NJ, 08512-7500, US

(21) Appl. No.: 10/882,695

(22) Filed: Jun. 29, 2004

Related U.S. Application Data
(60) Provisional application No. 60/483,874, filed on Jun. 30, 2003.

(51) Int. Cl. B32B 9/04; C08L 83/04; C08F 2/46

(52) U.S. Cl. 428/447; 524/860; 522/6

(57) ABSTRACT

The invention is directed to a polymeric microparticle containing silicone release composition having improved slip/shear, anti-block, transfer, and lower release properties. The silicone release composition may be formed of thermal or radiation cured solventless silicone release compositions. The silicone release composition may also be formed of a UV-cationic silicone release composition. The polymeric microparticles are preferably polymeric microspheres. The invention is further directed to the use of such microparticle containing silicone release compositions to coat a substrate, and release coated substrates formed thereof.

### FIELD OF THE INVENTION

The invention relates generally to silicone release coating compositions, the use of such silicone release coating compositions to coat a substrate, and a release coated substrate formed thereof. More particularly, the invention relates to thermal curable, radiation curable, and UV-cationic solventless silicone release coatings having improved slip/shear, transfer, anti-block, and lower release properties.

### BACKGROUND OF THE INVENTION

Silicone release coatings or compositions are well known and the subject of many publications and patents. They are useful in many applications where one requires a relatively non-adherent surface. In such applications release compositions are coated onto a substrate, and are caused to be cured. A particularly useful application is the coating of paper, polyethylene films, and other materials that are used among other applications for providing non-stick surfaces, pressure sensitive adhesive labels, decorative laminates, and transfer tapes.

Silicone polymers and copolymers have been used extensively in release compositions because they are inherently low in surface energy. The silicone polymers and copolymers (sometimes referred to as polyorganosiloxanes) used in the prior art for making release compositions can be radiation cured or thermally cured. Solventless silicone release compositions are also well known. The advantages of using solventless, radiation cured or thermally cured release compositions are well known to the person skilled in the art of release coatings.

In non-radiation cure silicone-release compositions, release performance in such coatings is characteristic of the base silicone polymer. Thermal cure versions of these polymers are generally standard polydimethylsiloxanes, which have been terminated with either vinyl or silanic hydrogen reactive groups, or they are copolymers of polydimethyl and methylvinylsiloxane. These copolymers can also be terminated with vinyl reactive groups as in the case of the standard polydimethylsiloxanes. Solventless compositions generally do not include any organic solvent such as toluene or xylene.

It is desirable that release-coated papers and films have a release force which is low enough to enable the release backing sheet to be easily removed from a coated substrate, but not so low that the release backing sheet will become separated from the coated surface prior to when desired by forces normally encountered in handling and processing. “Release force” is defined as the amount of force required to peel or separate the release-coated substrate from the adhesive. While various release compositions have been provided that limit an increase in release force, there has not been such success in lowering the release force below that which is the normal minimum of the silicone release composition. Often the force below the normal minimum release force is known in the art as the premium release level and accordingly, a release coating which exhibits a low release force, is referred to in the art as a “premium release”.

Furthermore, silicone layers (also referred to as sheets or films) with smooth surfaces possess a high coefficient of friction such that they tend to “block” or adhere to each other. The term “blocking” also generally refers to the sticking of one layer, for example a silicone layer, to another layer, for example a non-silicone side of another layer. Accordingly, the term “anti-block” is used to describe preventing such adhesion and when referring to materials coated onto film sheets, “antiblocking agents,” and “antifriction agents” all refer to materials which are used to prevent two sheets from adhering together.

During manufacture and storage of the coated sheets prior to use, free silicone oil is inevitably released from the coated sheet onto the surface of another coated sheet leaving discrete patches of free silicone oil on the sheet surface. This creates what is referred to as high “slip”. Free silicone oil can also be transferred easily to the non-silicone-coated back side of the sheet. When, for example, the coated sheet is stored in a front surface to back surface contact manner, as in a typical roll, some of the free silicone oil (typically low molecular weight silicones) on the front silicone coated surface of the sheet will be transferred to the back (typically uncoated) surface of the roll.

In practice, this free silicone oil contamination can be a drawback. For example, when the coated sheet traverses over idler rolls during subsequent processing steps (e.g., during label application), the idler rolls can slip and lose contact with the sheet. This can result in uneven tension on the sheet web or loss of alignment. Related problems arise when printing on the resulting silicone-coated sheet or when labels are applied to the sheet. The ability of printing inks and solvents to adhere is impaired by the presence of free silicone oil on the surface to be printed. Moreover, loss of alignment due to the sheet's high slip can lead to a high reject rate during printing, particularly where multiple printing passes are used and in cases where proper alignment is critical for formation of an integrated image. Transfer and backside transfer of silicone from one layer, for example a silicone coated layer, onto another layer, for example a non-silicone layer, is also causes the layers to adhere to each other.

Accordingly, there exists a need in the art to provide a silicone release composition with lower release properties. A need also exists to provide silicone release compositions which reduce or prevent slip, blocking and transfer and which impart a significantly lower coefficient of friction compared to known methods of preventing adhesion between film sheets. Furthermore, silicone materials also tend to be costly, thus there is also a need to minimize the amount of silicone material required for making the release composition.

### SUMMARY OF THE INVENTION

The invention is directed to a silicone release composition containing polymeric microparticles, preferably microspheres. In one aspect, the invention is directed to a radiation curable solventless silicone release composition containing polymeric microparticles. In another aspect, the invention is directed to a UV-cationic or free radical silicone release composition containing polymeric microparticles. In yet another aspect, the invention is directed to a thermal curable silicone release composition containing polymeric microparticles.

A further aspect of the invention comprises a method for producing a release coating on a substrate by applying the aforedescribed release composition containing microparticles to a substrate and curing the coating on the substrate. The coating may be cured by exposing the coating to radiation or heat. A still further aspect of this invention comprises a release coated article comprising a substrate which has been coated with the release composition containing microparticles and has optionally been cured by exposure to radiation or heat.

### BRIEF DESCRIPTION OF THE DRAWINGS

These and other features and advantages of the invention will be better understood from the following detailed description, which is provided in connection with the accompanying drawing.

FIG. 1A is a photograph of a silicone release composition without microparticles.

FIG. 1B is a photograph of a silicone release composition having microparticles therein in accordance with the invention.

### DETAILED DESCRIPTION OF INVENTION AND PREFERRED EMBODIMENTS

A first subject of the invention is a release coating, characterized in that it comprises, as a mixture:
(1) at least one heat or radiation curable organopolysiloxane polymer (2) a catalytically effective amount of at least one initiator, and (3) polymeric microparticles.

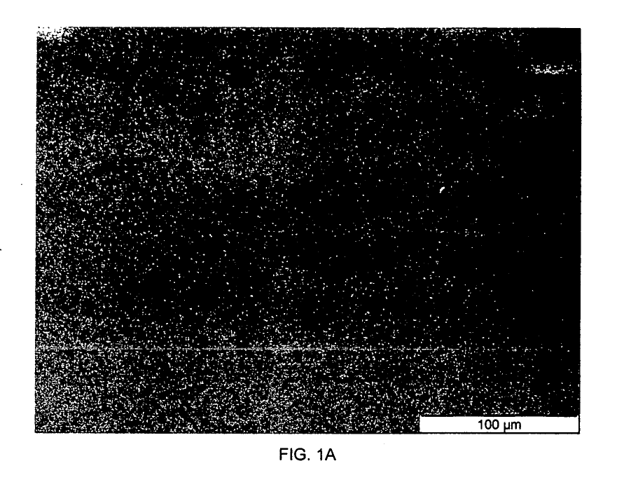

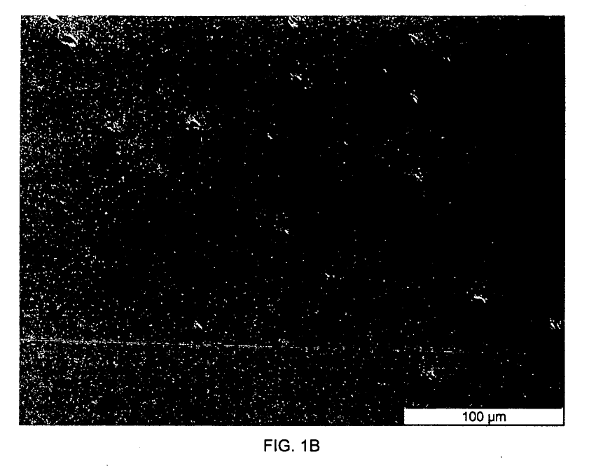

The addition of polymeric microparticles in combination with the other silicone components makes it possible to achieve the desired properties. Thanks to the slight protrusion of the microparticles, silicone contact is slightly minimized to reduce the coefficient of friction thereby improving release, transfer, and slip/shear properties of the release composition. FIG. 1A shows a silicone release composition without microparticles and FIG. 1B shows a silicone release composition having microparticles therein, in accordance with the invention. The slight protrusions of the microparticles, as shown in FIG. 1B, helps impart improved release coating properties. The microparticles also contribute to lowering the density of the release composition. As such, less silicone will be required to coat a particular surface.

The polymeric microparticles maybe of any suitable shape, and are preferably spherical, e.g., microspheres. The microparticles may be in solid or hollow form. Hollow microspheres do not have the crush resistance exhibited by solid spheres and cannot be used in systems requiring high-shear mixture or high-pressure molding. The polymeric microparticles may be formed of any suitable polymeric material, and preferably is formed of a polyethylene material and more preferably polytetrafluoroethylene (PTFE) or combinations of polyethylene and PTFE materials. Preferred microparticles are sold under the name Polyfluo® by Micro Powders Inc and Ceraflour® by BYK-Cera bv. The microparticles preferably have a softening or melting point of at least about 100° C., and more preferably of at least about 300° C.

The microparticles may also be expandable organic microparticles comprising, as is known in the art, a polymer wall having a liquid or a gas formed therein. These microparticles are expanded by heating them beyond the softening point of the polymer and to a temperature sufficient to vaporize the liquid or suitably expand the gas, which can be, for example, an alkane, such as isobutane or isopentane. The wall can be composed, of polymers or copolymers, for example prepared from vinyl chloride, vinylidene chloride, acrylonitrile, methyl methacrylate or styrene monomers, or mixtures of polymers and/or copolymers, for example, in particular, acrylonitrile/methacrylonitrile copolymer or acrylonitrile/vinylidene chloride copolymer. (See in particular U.S. Pat. No. 3,615,972.) A preferred expandable organic microparticle is sold under the name Dualite® by UCB Chemicals.

Expandable organic microparticles can be incorporated in the composition without distinction in the expanded state or before their expansion, which can be induced by appropriate heating.

It may be advantageous for the microparticles or microspheres to be surface treated, as is known in the art, in order to promote dispersion in the composition. Suitable surface treatment materials include silica or salts or hydroxides of metals such as Ca, Mg, Ba, Fe, Zn, Ni, Mn, as is described for example in EP-A-486,080, or else carbonates, for example calcium carbonate.

The polymeric microparticles may be any suitable size, and are preferably slightly larger than the required release composition thickness, in order to allow a slight protrusion. The expandable organic microparticles are present for example, in a proportion of about 0.1% to about 30% by weight, preferably about 0.5% to about 10% by weight and more preferably about 2% to about 4% by weight with respect to the total composition.

In the case where microspheres are used, the microspheres will preferably have a diameter of between about 0.5 μm and about 15 μm and more particularly between about 1 μm and about 4 μm. The microspheres are preferably present in an amount of for example about 0.5% to about 30% by weight, preferably from about 0.5% to about 10% by weight, and more preferably from about 0.5% to about 3% by weight with respect to the total composition. Pre-expansion microspheres will preferably have a diameter of between about 0.1 μm and about 10 μm and more preferably between about 0.5 μm and about 3 μm. A post-expansion (in situ or original) diameter of between about 1 μm and about 15 μm, preferably between about 1 μm and about 4 μm, is preferred.

A composition according to a first aspect of the invention advantageously comprises a radiation curable solventless release composition. Any suitable radiation curable solventless release composition may be used. One such preferred composition is a radiation curable solventless release coating as described in U.S. Pat. No. 6,548,568, which is incorporated herein by reference.

Accordingly, a preferred polymeric microparticle containing radiation curable solventless release composition as described in the aforesaid mentioned patent comprises:
(a) from about 50 to about 100 parts by weight of an organopolysiloxane of the formula (I) 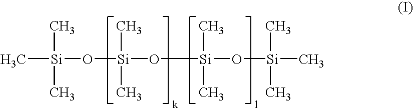
   wherein R is CH₂═C(Y)—C(O)—O—CH₂—CH(OH)—CH₂—O—CH₂—CH₂—CH₂—, (CH₂═C(Y)—C(O)—O—CH₂)₂C(CH₂—CH₃)—CH₂—O—CH₂—CH₂—CH₂—, CH₂═C(Y)—C(O)—O—(CH₂)₄—O—(CH₂)₂—, or CH₂═C(Y)—C(O)—O—(CH₂)₆—O—(CH₂)₂— and wherein Y═H or (CH₃)—, k is from about 5 to about 15, and I is from about 50 to about 150;
(b) from 0 to about 50 parts by weight of one or more organopolysiloxanes comprising organopolysiloxanes selected from the group consisting of those of formulae (II) and (III) 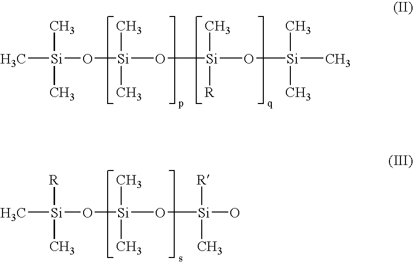
   wherein R and R′ are selected from the group consisting of CH₂═C(Y)—C(O)—O—CH₂—CH(OH)—CH₂—O—CH₂—CH₂—CH₂—, (CH₂═C(Y)—C(O)—O—CH₂)₂C(CH₂—CH₃)—CH₂—O—CH₂—CH₂—CH₂—, CH₂═C(Y)—C(O)—O—(CH₂)₄—O—(CH₂)₂—, or CH₂═C(Y)—C(O)—O—(CH₂)₆—O—(CH₂)₂—; Y is H or (CH₃)—, p is from about 0 to about 300, q is from about 1 to about 20, and s is from about 0 to about 300;
(c) from 0 to about 10 parts by weight of at least one additive for modifying the adhesion and flexibility properties of the composition, the at least one additive selected from the group consisting of acrylate and vinyl ether monomers;
(d) from 0 to about 10 parts by weight of a photoinitiator; and
(e) from about 0.1 to about 5 parts by weight polymeric microparticles.

For easier release, at least one of component (b) or (c) is preferably present in the composition. The polymeric microparticles containing radiation-curable solventless silicone release compositions in accordance with the invention are produced by mixing microparticles in an amount of from about 0.1 to about 5 parts by weight of the total composition with the silicone components of the aforementioned components of the composition. The microparticles may be mixed into any of the components (a), (b), (c) or (d) or any combination thereof. The microparticle and component(s), may be mixed at room temperature with stirring. In some instances, it may be desirable to employ mild heating to facilitate mixing. However, the main silicone components and microparticles are very compatible when blended into one another and generally do not require them to be maintained under continuous stirring and heat to keep the system homogeneous.

The polymeric microparticles containing radiation-curable solventless silicone release compositions of the invention can be stabilized against premature polymerization during storage by the addition of conventional polymerization inhibitors, such as hydroquinone, monomethylether of hydroquinone, phenothiazine, di-t-butyl paracresol, and the like. Amounts of about 0.1 weight percent or less of the stabilizers are generally effective.

The polymeric microparticles containing radiation-curable solventless silicone release compositions of the invention generally are applied to a substrate prior to curing. The compositions may be applied to a substrate as a coating by any conventional means known in the coating art, such as roller coating, curtain coating, brushing, spraying, reverse roll coating, doctor knife, dipping, die coating and the like.

A wide variety of substrates can be coated with the polymeric microparticles containing radiation-curable solventless silicone release compositions of the invention. These compositions can be applied to any suitable substrate when it is desirable to modify the release properties of a surface of the substrate. For example, the compositions of the invention can be employed to form release coatings on substrates, such as paper, vinyl, polyvinyl chloride, and polyester polyolefin films, non-woven fabrics, glass, steel, aluminum, and the like. Included among the types of paper which can be used is clay coated paper, polymer coated paper, paperboard from straw, bark, wood, cotton, flax, cornstalks, sugarcane, bagasse, bamboo, hemp, and similar cellulose materials prepared by such processes as the soda, sulfite or sulfate (Kraft) processes, the neutral sulfide cooking process, alkali-chlorine processes, nitric acid processes, semi-chemical processes, and the like. Examples of papers which can be utilized as substrates in preparing the composite laminates of the invention include Kraft papers such as 40-pound and 50-pound bleached Kraft papers, 41-pound offset grade bleached Kraft paper, and the like.

The amount of radiation-curable solventless silicone release compositions of the invention applied to the various substrates will vary depending upon the characteristics of the substrate, the properties desired in the release coating, the radiation source utilized, and the particular formulation of the release composition. Generally, it is desired to apply the least amount of coating to obtain the desired result. Thus, applied coating weights may range from about 0.1 to about 10 or more grams/m² depending on the substrate and intended use.

The polymeric microparticles containing radiation curable solventless silicone release compositions of the invention can be cured by exposure to known forms of radiation, especially ultraviolet light or ionizing radiation, such as electron beam radiation. One of the advantages of using ultraviolet radiation to effect cure of the composition is that polymerization takes place rapidly at ambient temperature, and heating is not necessary. The preferred ultraviolet radiation used has a wavelength of from about 0.15 μm to about 0.4 μm, preferably from about 0.20 μm to about 0.35 μm. The duration of irradiation can be short and it is generally less than 1 second and is on the order of a few hundreds of a second for very thin coatings. A preferred curing process would be a high speed cure of about 200 m/min at 240 W/cm using two radiation lamps.

A composition according to another aspect of the invention advantageously comprises a radiation curable cationic silicone release composition, commonly referred to as a “UV-cationic” silicone release composition and microparticles. UV-cationic silicone release compositions are generally based on epoxy-silicone copolymer technology that is blended with a cationic curing agent or photoinitiator. The epoxy-silicone copolymer technology generally has the following composition, as described in U.S. Pat. No. 5,340,898 which is herein incorporated by reference:
a curable epoxypolyorganosiloxane having a linear or a substantially linear polymer of recurring structural units of formula (IV) and end groups of formula (V); or are cyclic and comprise recurring structural units of formula (IV) 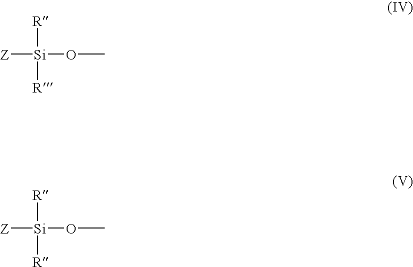
   wherein formulae the symbol R″, which may be identical or different, represents a C1-C6 linear or branched alkyl radical; a C5-C8 cycloalkyl radical, an aryl radical; or a substituted aryl radical. At least 60 molar % of the radical R″ is preferably a methyl radical. Z is preferably from a group as defined by R″ or a cationically crosslinkable functional organic radical being bonded to an atom of the silicone chain via a divalent bridge having from about 2 to about 20 carbon atoms whereby at least one of the Z components is a crosslinkable functional epoxy containing organic radical. Z may be identical or vary for each of the recurring structural units.

The epoxy or vinyloxyfunctional polyorganosiloxanes are described generally in DE-A-4,009,899; EP-A-396,130; EP-A-355,381; EP-A-105,341; FR-A-2,110,115; and Fr-A-2,526,800, which are incorporated by reference herein.

For example, a polymeric microparticle containing UV-cationic silicone release composition may comprise:
(a) a curable epoxypolyorganosiloxane having a linear or a substantially linear polymer of recurring structural units according to formula (IV) and end groups of formula (V) as described in U.S. Pat. No. 5,866,261, which is incorporated by reference herein;
(b) a crosslinkable silicone hydride resin having no epoxy functionality, as also described in U.S. Pat. No. 5,866,261, and having a crosslinkable silicone hydride resin of the formula:
   M_{α}D_{β}T_{χ}Q_{δ}(ORⁱ)_{ε}
   wherein M=R₃ SiO_{1/2}, D=R₂ SiO2/2, T=RSiO_{3/2} and Q=SiO_{4/2};
(c) a cationic photocuring initiator effective in initiating cationic curing of the epoxy functional siloxane; and
(d) polymeric microparticles

Any suitable UV-cationic silicone release composition may be used. For example, a suitable polymeric microparticle containing UV-cationic silicone release composition may comprise:
(a) at least a liquid polyorganosiloxane having a viscosity of about 10 to 10,000 mPa's at 25° C. and bearing a crosslinkable/polymerisable function Z on at least an M and/or T unit, and /or at least a crosslinkable/polymerisable function on at least a D unit
(b) a cationic photoinitiator of onium borate type; and
(c) microparticles.

Another suitable UV-cationic silicone release composition is a “premium release” composition. As discussed above, premium release, relates to a release composition that has low release properties. Preferred premium release compositions are commercially available under the name Silcolease® by Rhodia Inc.

One such UV-cationic premium release composition comprises:
a.1) about 50 to about 99 parts by weight and preferably about 70 parts of a curable epoxypolyorganosiloxane formula (VI) 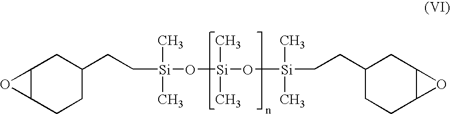
   wherein n is between about 10 to about 100, and preferably about 20;
b.1) about 1 to about 50 parts by weight and preferably about 30 parts by weight of the polyorganosiloxane having formula (VI), 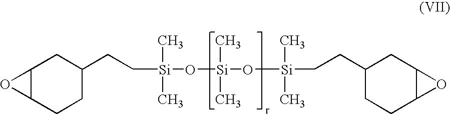
   wherein r is between about 150 to about 300, and preferably about 220;
c.1) about 0.1 to about 5 parts by weight and preferably about 2.5 parts by weight of a cationic initiator; and
d.1) about 0.1 to about 5 parts by weight and preferably about 1 part by weight microparticles.

The cationic initiator is preferably of an onium salt. Suitable onium borate initiators are discussed in U.S. Pat. Nos. 5,340,898 and 5,468,902, which are herein incorporated by reference. Other cationic curing agents or photoinitiators can alternatively be selected for use.

Another preferred polymeric microparticle containing UV-cationic silicone premium release composition comprises:
a.2) about 50 to about 99 parts by weight and preferably about 60 parts of a curable epoxypolyorganosiloxane of formula (VI), wherein n is between about 10 to about 100, and preferably about 20;
b.2) about 1 to about 50 parts by weight and preferably about 30 parts by weight of the polyorganosiloxane of formula (VII), wherein r is between about 150 to about 300, and preferably about 220;
c.2) about 1 to about 20 parts by weight and preferably about 10 parts by weight of a polyorganosiloxane of a formula (VII), 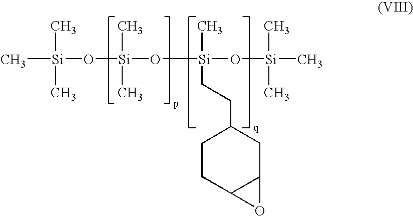
   wherein p is between about 0 to about 300 and preferably 70 and further wherein q is between about 1 to about 20 and preferably 8;
d.2) about 0.1 to about 5 parts by weight and preferably about 2.5 parts by weight of a cationic initiator; and
e.2) about 0.1 to about 5 parts by weight and preferably about 1 part by weight microparticles.

Yet another preferred polymeric microparticle containing UV-cationic silicone premium release composition comprises:
a.3) about 60 to about 99 parts by weight and preferably about 65 parts of the formula (VI) curable epoxypolyorganosiloxane, wherein n is between about 10 to about 100, and preferably about 20;
b.3) about 1 to about 40 parts by weight and preferably about 30 parts by weight of the formula (VII) polyorganosiloxane, wherein r is between about 150 to about 300, and preferably about 220;
c.3) about 1 to about 20 parts by weight and preferably about 5 parts by weight of the formula (VIII) polyorganosiloxane, wherein p is between about 100 to about 300 and p is preferably 200; and further wherein q is between about 1 to about 20 and q is preferably 3;
d.3) about 0.1 to about 5 parts by weight and preferably about 2.5 parts by weight of a cationic initiator; and
e.3) about 0.1 to about 5 parts by weight and preferably about 1 part by weight microparticles.

The microparticles in accordance with this aspect of the invention are preferably microspheres. The microspheres may be mixed into any of the individual components or any combination thereof. Preferably the microspheres are mixed in with formula (VI) or (VII) and are more preferably mixed in with formula (VII). The microparticles are preferably mixed in at a percentage by weight of between about 10% to about 50% of the formula, and more preferably between about 25 and about 40% by weight of the formula. The microparticle and component(s), may be mixed at room temperature with stirring. In some instances, it may be desirable to employ mild heating to facilitate mixing. However, the main silicone components and microparticles are very compatible when blended into one another and generally do not require them to be maintained under continuous stirring and heat to keep the system homogeneous.

Utilization of a microparticle containing UV-cationic silicone release composition in accordance with the invention results in a product having properties which are both tight (i.e., excellent adherence of a pressure sensitive adhesive to the coated substrate) but smooth upon release (i.e., the removal of the adhesive from the coated substrate occurs without a ratchet or zippered effect).

The UV-cationic silicone release compositions according to the invention can be used as such or in solution in an organic solvent. They are useful for providing anti-adherent coatings on cellulosic materials, films, paints, encapsulation of electrical and electronic components, coatings for textiles and for sheathing optical fibers. They are very particularly advantageous when they are used, as such, to produce a material, such as metal sheets, glass, plastics or paper that is non-adherent to other materials to which it would normally adhere. The composition advantageously exhibits a viscosity not exceeding 2,000 mpa.s.

Thus, the invention also features a process for the production of articles, comprising coating an amount of the UV-cationic silicone release composition of the invention, generally from about 0.1 to about 5 g/m², onto at least one face surface thereof, and cross linking the composition by supplying radiation (i.e., visible light, ultraviolet or electron beam radiation). The type of radiation source utilized is directly correlated to the curing agent selected. For example, when using initiators that liberate hydrogen proton cations upon exposure to ultraviolet radiation, the radiation source selected should be an ultraviolet wave source. The preferred ultraviolet radiation used has a wavelength of from about 0.2 μm to about 0.4 μm and preferably from about 0.23 μm to about 0.3 μm. The duration of irradiation can be short and it is generally less than 1 second and is on the order of a few hundreds of a second for very thin coatings. A preferred curing process is a high speed cure of about 200 m/min at 240 W/cm using two radiation lamps.

Curing may be performed in the absence of any heating. However, it should be appreciated that heating at a temperature of from about 25° C. to about 100° C. is also within the scope of the invention. It should also be appreciated that the curing times can be adjusted, by the number of radiation lamps used, by the duration of exposure to radiation and by the distance between the composition and the radiation lamp.

The amounts of UV-cationic silicone release composition deposited onto the substrates are variable and typically range from about 0.1 to about 5 g/m² of treated surface. These amounts depend on the nature of the substrates and on the desired anti-adherent or anti-block properties. They usually range from about 0.5 to about 3 g/m² for nonporous substrates.

While a primary application of the UV-cationic silicone release compositions in accordance with the invention are for single or double coated release liners for tapes, labels or personal care items (e.g., diapers), other applications include: embossing strip release liners, protective release surfaces for floor tiles and wall coatings, release papers for low pressure plastic laminates, release materials for interleaves, release materials for self-sealing roofing, bakery tray liners, and like applications where a release surface of some definite value exists.

A composition according to a third aspect of the invention advantageously comprises a thermal curable solventless release composition. Any suitable thermal curable solventless release composition may be used.

Accordingly, a preferred polymeric microparticle containing thermal curable solventless silicone release composition may comprise:
(a) from about 0 to about 50 parts by weight of an organopolysiloxane of formula (IX) wherein the Brookfield viscosity of formula (IX) is about 50 cps to about 45,000 cps at room temperature, and is more preferably about 180 cps; 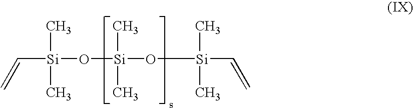
(b) from about 0 to about 25 parts by weight of formula (IX) wherein the Brookfield viscosity of formula (IX) is about 50,000 cps to about 150,000 cps and is more preferably about 100,000 cps;

Preferably, s is from about 0 to about 300;
(c) from 0 to about 50 parts by weight of formula (X) wherein the Brookfield viscosity of formula (X) is about 50 cps to about 50,000 cps and is more preferably about 450 cps; 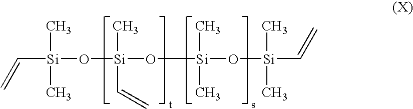
(d) from about 0 to about 15 parts of a crosslinkable polymer;
(e) from about 0 to about 10 parts of a platinum group based catalyst system; and
(f) from about 0.1 to about 5 parts polymeric microparticles.

Preferably, s is from about 0 to about 300 and t is from about 1 to 100.

The crosslinkable polymer may be any suitable polymer. Suitable crosslinkable polymers include, a homopolymer crosslinker having a general formula (XI) of for example: 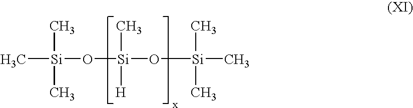
or a copolymer crosslinker having a general formula (XII) of for example:

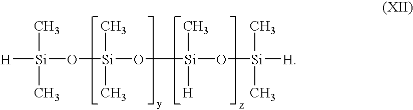

Preferably, y is from about 0 to about 300 and t is from about 1 to 100.

Optionally the composition may include from about 0 to about 15 parts of a flow modification agent which serves to enhance or otherwise control the viscosity or flow-ability of the final composition. A viscosity lowering material, for example, may be an alpha olefin having a general formula of CH₂═CH—[CH₂]₁₂.

Preferably the composition comprises microparticles in an amount of about 1 part by weight of the total composition. The microspheres may be mixed into any of the silicone components (a), (b), (c) or (d) or any combination thereof. As discussed above with regard to the other compositions in accordance with the invention, the microparticles and silicone component(s) may be mixed at room temperature with stirring. It may also be desirable to employ mild heating to facilitate mixing.

As discussed above with respect to the radiation-curable compositions, the thermal curable solventless silicone release compositions of the invention can also be stabilized against premature polymerization during storage by the addition of conventional polymerization inhibitors, such as hydroquinone, monomethylether of hydroquinone, phenothiazine, di-t-butyl paracresol, and the like. Again, amounts of about 0.1 weight percent or less of the stabilizers are generally effective.

The polymeric microparticles containing thermal curable solventless silicone release compositions of the invention generally are applied to a substrate prior to curing. The compositions may be applied to a substrate as a coating by any conventional means known in the coating art, such as roller coating, curtain coating, brushing, spraying, reverse roll coating, doctor knife, dipping, die coating and the like.

A wide variety of substrates can be coated with the thermal curable solventless silicone release compositions of the invention. These compositions can be applied to any suitable substrate when it is desirable to modify the release properties of a surface of the substrate. For example, thermal curable silicone release compositions are widely used in the graphic arts sheet label market. The amount of polymeric microparticle containing thermal curable solventless silicone release compositions of the invention applied to the various substrates will vary depending upon the characteristics of the substrate, the properties desired in the release coating, the heat source utilized, and the particular formulation of the release composition. Generally, it is desired to apply the least amount of coating to obtain the desired result. Thus, applied coating weights may range from about 1.3 g/m² to about 1.8 g/m² for most paper and clay coated substrates and from about 0.65 g/m² to about 1.15 g/m² for poly coated Kraft substrates and will vary widely depending on the substrate and intended use.

The thermal curable solventless silicone release compositions of the invention can be cured by exposure to known forms heat.

While not wishing to be bound to any specific scientific theory, the inventors hypothesize that the microparticles enhance the silicone release compositions. The combination of microparticles in the silicone release composition provides surprisingly unexpected synergies. The addition of the microparticles to silicone release compositions have shown improved slip/shear and anti-block properties. The addition of the microparticles to silicone release compositions has also shown lower release properties. Another benefit exhibited by the invention is lower transfer. The microparticles are believed to act as an effective anti-blocking agent.

In accordance with the invention, the compositions are able to provide release values on the order of between about 3 to about 25 grams per linear inch at pull rates of about 12 inches to 600 inches per minute.

In order to further illustrate the invention and the advantages thereof, the following non-limiting examples are given.

### EXAMPLES

### Example I

The starting formulations of the release coatings were:
60 parts by weight of a curable epoxypolyorganosiloxane compound VI, wherein n is 20
30 parts by weight of the polyorganosiloxane having compound VII, wherein r is 220
10 parts by weight of the polyorganosiloxane having compound VIII, wherein p is 200 and q is 3
2.5 parts by weight of a cationic initiator
1-3 parts polymeric microspheres

The photoinitiator employed in the test compositions was Silcolease® UV Cata211 available from Rhodia Inc., a cationic photoinitiator activated by UV radiation. The polymeric microparticles were polytetrafluoroethylene (PTFE) microsphere sold under the name FLUO HT® commercially available from Micro Powders Inc. The polymeric microspheres were prepared as a dilution in formula (VII) at 33% by weight of the formula.

The components were thoroughly mixed, applied to a polypropylene film at a coat weight of about 0.9 g/m² using a Dixon coater, and cured under two 240 W/cm ultraviolet lamps at a line speed of 200 meters per minute. Table 1 shows the results of the testing of the standard formulations and the standard formulations with 3 parts by weight of the total composition polymeric microspheres FLUO HT.

The following definitions and abbreviations are employed in the Tables:

Adhesives evaluated were acrylic adhesive tapes (commercial designations TESA4970 and TESA7475 available from Rhodia Inc.) and natural rubber adhesive tape (commercial designation TESA4651 available from Rhodia Inc.). The photoinitiator is commercially designated PC-702 and is available from Rhodia Inc. The microsphere are commercially designated XF-523 and are commercially available from Micro Powders Inc.

To demonstrate the improved release characteristics silicone release composition of the invention, standard UV-cationic silicone release compositions with and without polymeric microparticles were prepared, coated on a suitable substrate, cured by exposure to focused UV light, and the release values determined.

TABLE 1

| | | | Release Force: |
|---|---|---|---|
| Storage | | Release Force: | Composition with 1 |
| properties | Adhesive | Composition | Part Microspheres |
| 20 h at 23° C. | TESA4970 | 3.3 cN/cm | 3.2 cN/cm |
| 20 h at 70° C. | TESA4970 | 7.8 cN/cm | 4.3 cN/cm |
| 20 h at 23° C. | TESA7475 | 3.3 cN/cm | 2.9 cN/cm |
| 20 h at 70° C. | TESA7475 | 3.8 cN/cm | 3.3 cN/cm |
| 20 h at 23° C. | TESA4651 | 4.5 cN/cm | 3.9 cN/cm |
| 20 h at 70° C. | TESA4651 | 5.3 cN/cm | 4.3 cN/cm |

From Table 1, it can be seen that the release force for the compositions according to the invention was much lower than the compositions without the microspheres.

To further demonstrate the improved release properties of the silicone release composition of the invention, standard UV-cationic silicone release compositions with variable amounts of microspheres, from 0 to 3 parts by weight of the total composition were compared. The compositions containing the various percentages of microspheres were coated on a polyester (PET) film (commercial designation 2262 available from Mitsubishi), cured by exposure to focused UV light, and the release values determined. The Adhesive used was TESA4651.

TABLE 2
Mitsubishi 2262 PET Film off TESA4651 Rubber tape Release

| | Release | Release | Release | Release |
|---|---|---|---|---|
| | Force | Force | Force | Force |
| | 1 day at | 1 day at | 1 day at | 1 day at |
| | 23° C. | 23° C. | 70° C. | 70° C. |
| | cN/inch | cN/inch | cN/inch | cN/inch |
| % w/w | Pull speed | Pull speed | Pull speed | Pull speed |
| Microspheres | 12 Inch/min | 12 Inch/min | 12 Inch/min | 600 Inch/min |
| 0 | 14 | 15 | 22 | 25 |
| 1 | 4 | 3 | 10 | 13 |
| 3 | 5 | 2 | 13 | 11 |

From Table 2, it can be seen that the release force for the compositions containing microparticles according to the invention were much lower than the compositions without the microparticles for both pull speeds.

To further demonstrate the improved properties of the silicone release composition of the invention, standard UV-cationic silicone release compositions with 1.5 part microspheres, with 3 part microspheres and without microspheres were prepared, coated on Mitsubishi 2262 film, cured by exposure to focused UV light, and various properties were measured.

TABLE 3

| | | | | | | | Tape Area: 1 × 7″ | | | | | |
|---|---|---|---|---|---|---|---|---|---|---|---|---|
| | | | Liner: | | | | Tape Aging Condition: RT & Keil Age | | | | | |
| | | | Mitsubishi 2262 PET film | | | | (24 hr delay before lamination) | | | | | |
| | | | 1 | 2 | 3 | 4 | 5 | 6 | 7 | 8 | 9 | 10 |
| Bath Formulation: | | | | | | | | | | | | |
| Formula (VIII) | | | 10 | 10 | 10 | 10 | 10 | 10 | 10 | 10 | 10 | 10 |
| Formula (VII) | | | 30 | 30 | 30 | 30 | 30 | 30 | 30 | 30 | 30 | 30 |
| Formula (VI) | | | 60 | 60 | 60 | 60 | 60 | 60 | 60 | 60 | 60 | 60 |
| Microparticles | | | | | | | 1.5 | 1.5 | 3 | 3 | 3 | 3 |
| Photoinitiator | | | 2.5 | 2.5 | 2.5 | 2.5 | 2.5 | 2.5 | 2.5 | 2.5 | 2.5 | 2.5 |
| Coat Weight: | | | N/A | N/A | N/A | N/A | 0.703 | 0.725 | 0.671 | 0.709 | 0.701 | 0.693 |
| Line Speed | | | 200 | 400 | 200 | 400 | 200 | 400 | 200 | 400 | 200 | 400 |
| Release Force (g/in) | TESA4970 | | | | | | | | | | | |
| 24 hr delay before | 12 ipm, | 23° C. | Blocking | Blocking | Blocking | Blocking | 6 | 6 | 6 | 5 | 6 | 6 |
| lamination | | 70° C. | | | | | 7 | 7 | 7 | 6 | 7 | 6 |
| | 600 ipm, | 23° C. | Blocking | Blocking | Blocking | Blocking | 23 | 24 | 23 | 21 | 20 | 19 |
| | | 70° C. | | | | | 24 | 21 | 20 | 24 | 22 | 24 |
| | TESA7475 | | | | | | | | | | | |
| | 12 ipm, | 23° C. | Blocking | Blocking | Blocking | Blocking | 6 | 7 | 6 | 5 | 6 | 8 |
| | | 70° C. | | | | | 9 | 9 | 8 | 9 | 9 | 11 |
| | 600 ipm, | 23° C. | Blocking | Blocking | Blocking | Blocking | 8 | 20 | 17 | 18 | 15 | 17 |
| | | 70° C. | | | | | 24 | 19 | 23 | 25 | 24 | 25 |
| | TESA4651 | | | | | | | | | | | |
| | 12 ipm, | 23° C. | Blocking | Blocking | Blocking | Blocking | 5 | 5 | 3 | 4 | 4 | 6 |
| | | 70° C. | | | | | 6 | 6 | 4 | 3 | 6 | 7 |
| | 600 ipm, | 23° C. | Blocking | Blocking | Blocking | Blocking | 18 | 10 | 10 | 11 | 11 | 9 |
| | | 70° C. | | | | | 12 | 13 | 11 | 12 | 14 | 16 |
| Transfer* | | | n/a | n/a | n/a | n/a | 3 | 3 | 3 | 3 | 4 | 4 |
| Blocking* | | | yes | yes | slight | slight | no | no | no | no | slight | slight |

*Blocking is measured by an internal appreciation from 1 to 5 with 5 being best or no blocking. Transfer is determined by applying a marker trace on the backside of the liner to determine whether there is some ink dewetting on spots. An internal appreciation from 1 to 5 is used to measure this characteristic, with 5 being best or no transfer.

*Blocking is measured by an internal appreciation from 1 to 5 with 5 being best or no blocking. Transfer is determined by applying a marker trace on the backside of the liner to determine whether there is some ink dewetting on spots. An internal appreciation from 1 to 5 is used to measure this characteristic, with 5 being best or no transfer.

From Table 2, it can be seen that the release force and blocking for the compositions according to the invention was much lower than the compositions without the microspheres.

1. A silicone release coating composition comprising a mixture of a curable organopolysiloxane polymer selected from the group consisting of radiation curable organopolysiloxane polymers or heat curable organopolysiloxane polymers; a catalytically effective amount of at least one initiator; and polymeric microparticles.

2. The coating composition of claim 1 wherein said polymeric microparticles comprise a polyethylene material or a polytetrafluoroethylene material.

3. The coating composition of claim 1 wherein said polymeric microparticles having a melting point of at least about 100° C.

4. The coating composition of claim 1 wherein said polymeric microparticles having a melting point of at least about 300° C.

5. The coating composition of claim 1 wherein said polymeric microparticles provide a protrusion in said mixture.

6. The coating composition of claim 1 wherein said polymeric microparticles having a diameter of between about 0.5 μm and about 15 μm.

7. The coating composition of claim 1 comprising from about 0.5% to about 30% by weight of said polymeric microparticles.

8. The coating composition of claim 1 comprising from about 0.5% to about 10% by weight of said polymeric microparticles.

9. The coating composition of claim 1 comprising from about 0.5% to about 5% by weight of said polymeric microparticles.

10. The coating composition of claim 1 wherein said polymeric microparticles are solid.

11. The coating composition of claim 1 wherein said polymeric microparticles are hollow.

12. A silicone release coating composition comprising from about 25 to about 150 parts of a curable organopolysiloxane polymer; up to about 10 parts by weight of a catalytically effective amount of at least one initiator; and from about 0.01 to about 5 parts polymeric microparticles.

13. The coating composition of claim 12 wherein said polymeric microparticles comprise expandable organic microparticles having a polymer wall comprising a liquid or a gas formed therein.

14. The coating composition of claim 13 wherein said polymeric microparticles comprise microspheres.

15. The coating composition of claim 12 wherein said release coating composition has a thickness which is less than the size of the polymeric microparticles.

16. The coating composition of claim 14 wherein said microspheres have a pre-expansion diameter of from about 0.1 μm to about 10 μm.

17. The coating composition of claim 16 wherein said microspheres have a pre-expansion diameter of from about 0.5 μm to about 3 μm.

18. The coating composition of claim 14 wherein said microspheres have a post-expansion diameter of from about 1 μm to about 15 μm.

19. The coating composition of claim 18 wherein said microspheres have a post-expansion diameter of from about 1 μm to about 4 μm.

20. A polymeric microparticle containing release composition comprising:
(a) from about 50 to about 100 parts by weight of an organopolysiloxane of the formula (I) 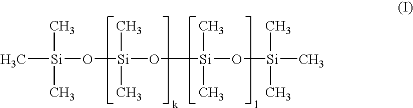
wherein R is CH₂═C(Y)—C(O)—O—CH₂—CH(OH)—CH₂—O—CH₂—CH₂—CH₂—, (CH₂═C(Y)—C(O)—O—CH₂)₂C(CH₂—CH₃)—CH₂—O—CH₂—CH₂—CH₂—, CH₂═C(Y)—C(O)—O—(CH₂)₄—O—(CH₂)₂—, or CH₂═C(Y)—C(O)—O—(CH₂)₆—O—(CH₂)₂— and wherein Y═H or (CH₃)—, k is 5 to 15, and I is 50 to 150;
(b) from 0 to about 50 parts by weight of one or more organopolysiloxanes comprising organopolysiloxanes selected from the group consisting of those of formulae (II) and (III). 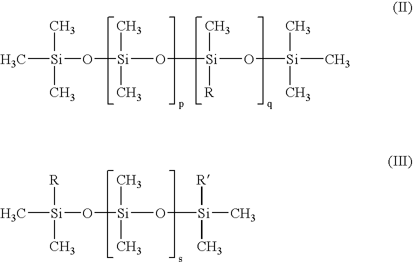
wherein R and R′ are selected from the group consisting of CH₂═C(Y)—C(O)—O—CH₂—CH(OH)—CH₂—O—CH₂—CH₂—CH₂—, (CH₂═C(Y)—C(O)—O—CH₂)₂C(CH₂—CH₃)—CH₂—O—CH₂—CH₂—CH₂—, CH₂═C(Y)—C(O)—O—(CH₂)₄—O—(CH₂)₂—, or CH₂═C(Y)—C(O)—O—(CH₂)₆—O—(CH₂)₂— and wherein Y═H or (CH₃)—, p is 0 to 300, q is 1 to 20, and s is 0 to 300;
(c) from 0 to about 10 parts by weight of at least one additive for modifying the adhesion and flexibility properties of the composition;
(d) from 0 to about 10 parts by weight of a photoinitiator; and
(e) from about 0.1 to about 5 parts by weight polymeric microparticles.

21. The composition of claim 20 wherein said at least one additive for modifying adhesion is selected from the group consisting of acrylate and vinyl ether monomers.

22. The composition of claim 20 comprising at least component (b) or (c).

23. A polymeric microparticle containing silicone release composition comprising:
(a) a curable epoxypolyorganosiloxane having a linear or a substantially linear polymer of recurring structural units according to formula (IV) and end groups of formula (V) 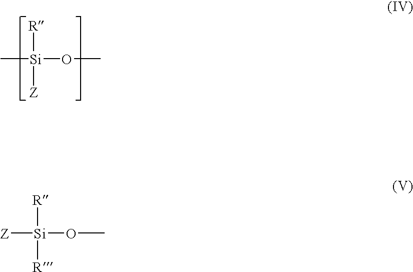
wherein R″ and R′″, are selected from the group consisting of a C1-C6 linear or branched alkyl radical; a C5-C8 cycloalkyl radical; an aryl radical; or a substituted aryl radical; and wherein Z, is selected from the group consisting of a C1-C6 linear or branched alkyl radical; a C5-C8 cycloalkyl radical; an aryl radical; a substituted aryl radical; or a cationically crosslinkable functional organic radical being bonded to an atom of the silicone chain via a divalent bridge having from about 2 to about 20 carbon atoms;
(b) a crosslinkable silicone hydride resin having a crosslinkable silicone hydride resin of the formula:
MαDβTχQδ(OR″)ε
wherein M=R″₃SiO_{1/2}, D=R″₂SiO_{2/2}, T=R″SiO_{3/2}, Q=SiO_{4/2} and R is CH₂═C(Y)—C(O)—O—CH₂—CH(OH)—CH₂—O—CH₂—CH₂—CH₂—, (CH₂═C(Y)—C(O)—O—CH₂)₂C(CH₂—CH₃)—CH₂—O—CH₂—CH₂—CH₂—, CH₂═C(Y)—C(O)—O—(CH₂)₄—O—(CH₂)₂—, or CH₂═C(Y)—C(O)—O—(CH₂)₆—O—(CH₂)₂;
(c) a cationic photocuring initiator effective in initiating cationic curing of the epoxypolyorganosiloxane; and
(d) polymeric microparticles.

24. The composition of claim 23 wherein said cationic photoinitiator is of an onium borate type.

25. The composition of claim 23 wherein at least one Z unit comprises a crosslinkable functional epoxy containing organic radical.

26. The composition of claim 23 wherein at least 60 molar percent of R″ or R′″ is a methyl radical.

27. A silicone release coating composition comprising:
(a) at least a liquid polyorganosiloxane having a viscosity of about 10 to 10,000 mPa's at 25° C. and bearing a crosslinkable function Z on at least an R″₃ SiO_{1/2} unit, R″SiO_{3/2} unit, or R″₂ SiO_{2/2} unit,
wherein Z, is selected from the group consisting of a C1-C6 linear or branched alkyl radical; a C5-C8 cycloalkyl radical, an aryl radical; a substituted aryl radical or a cationically crosslinkable functional organic radical being bonded to an atom of the silicone chain via a divalent bridge having from about 2 to about 20 carbon atoms, and R is CH₂═C(Y)—C(O)—O—CH₂—CH(OH)—CH₂—O—CH₂—CH₂—CH₂—, (CH₂═C(Y)—C(O)—O—CH₂)₂C(CH₂—CH₃)—CH₂—O—CH₂—CH₂—CH₂—, CH₂═C(Y)—C(O)—O—(CH₂)₄—O—(CH₂)₂—, or CH₂═C(Y)—C(O)—O—(CH₂)₆—O—(CH₂)₂;
(b) a cationic photoinitiator; and
(c) microparticles.

28. A polymeric microparticle containing silicone release composition comprising:
a.1) about 50 to about 99 parts by weight and preferably about 70 parts of a curable epoxypolyorganosiloxane of formula 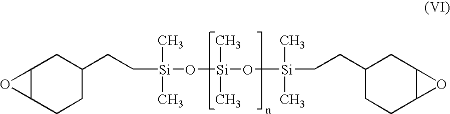
wherein n is between about 10 to about 100,;
b.1) about 1 to about 50 parts by weight and preferably about 30 parts by weight of a polyorganosiloxane having formula (VI), 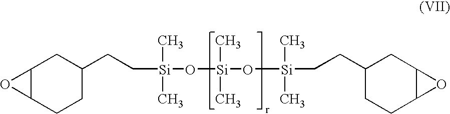
wherein r is between about 150 to about 300;
c.1) about 0.1 to about 5 parts by weight of a cationic initiator; and
d.1) about 0.1 to about 5 parts by weight microparticles.

29. The composition of claim 28 wherein n is 20.

30. The composition of claim 28 wherein r is about 220.

31. The composition of claim 28 comprising about 2.5 parts by weight cationic initiator.

32. The composition of claim 31 comprising about 1 part by weight microparticles.

33. A polymeric microparticle containing silicone release composition comprising:
a.2) about 50 to about 99 parts by weight of a curable epoxypolyorganosiloxane of formula (VI), wherein n is between about 10 to about 100; 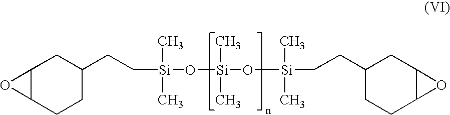
b.2) about 1 to about 50 parts by weight of the polyorganosiloxane of formula (VII), wherein r is between about 150 to about 300; 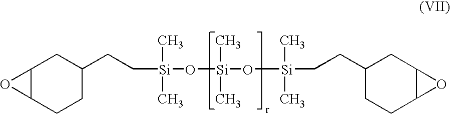
c.2) about 1 to about 20 parts by weight of a polyorganosiloxane of formula (VIII), 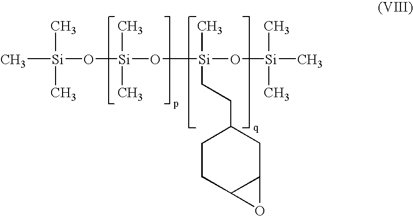
wherein p is between about 0 to about 300 and further wherein q is between about 1 to about 20;
d.2) about 0.1 to about 5 parts by weight of a cationic initiator; and
e.2) about 0.1 to about 5 parts by weight microparticles.

34. The composition of claim 33 comprising about 60 parts by weight of curable epoxypolyorganosiloxane of formula (VI); about 30 parts by weight of polyorganosiloxane of formula (VII); about 10 parts by weight of polyorganosiloxane of formula (VIII); about 2.5 parts by weight cationic initiator; and about 1 party by weight microparticles.

35. The composition of claim 33 wherein n is about 20, r is about 220, p is about 70, and q is about 8.

36. The composition of claim 33 comprising about 65 parts by weight of curable epoxypolyorganosiloxane of formula (VI); about 30 parts by weight of polyorganosiloxane of formula (VII); about 5 parts by weight of polyorganosiloxane of formula (VIII); about 2.5 parts by weight cationic initiator; and about 1 party by weight microparticles.

37. The composition of claim 36 wherein n is about 20, r is about 220, p is about 200, and q is about 3.

38. The composition of claim 33 wherein said microparticles comprise microspheres.

39. A polymeric microparticle containing thermal curable solventless silicone release composition comprising:
(a) from about 0 to about 50 parts by weight of an organopolysiloxane of formula (IX) wherein the Brookfield viscosity of formula (IX) is about 50 cps to about 45,000 cps at room temperature; 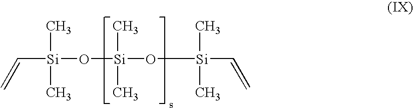
(b) from about 0 to about 25 parts by weight of formula (IX) wherein the Brookfield viscosity of formula (IX) is about 50,000 cps to about 150,000 cps;
(c) from 0 to about 50 parts by weight of formula (X) wherein the Brookfield viscosity of formula (X) is about 50 cps to about 50,000 cps, t is about 1 to about 20, and s is about 0 to about 300 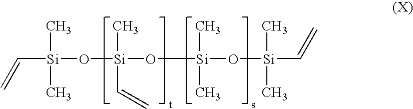
(d) from about 0 to about 15 parts of a crosslinkable polymer;
(e) from about 0 to about 10 parts of a platinum group based catalyst system; and
(f) from about 0.1 to about 5 parts polymeric microparticles.

40. The composition of claim 39 wherein the Brookfield viscosity of component (a) is about 180 cps, component (b) is about 100,000cps, and component (c) is about 450 cps.

41. The composition of claim 41 wherein said crosslinkable polymer is selected from the group consisting of formula (XI) or (XII)

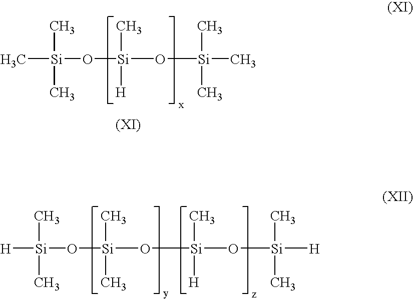

42. The composition of claim 41 further comprising a viscosity lowering material.

43. The composition of claim 42 wherein said viscosity lowering material comprises an alpha olefin of formula CH₂═CH—[CH₂]₁₂.

44. The composition of claim 39 wherein m is from 1 to 100 and n is from 0 to 1000.

45. A method for producing a release coating on a substrate comprising:
applying a coating of the silicone release coating composition of claim 1 to a substrate; and
curing the coating on the substrate by exposing the coating to radiation or heat.

46. A method for producing a release coating on a substrate comprising:
applying a coating of a silicone release coating composition of claim 12 to a substrate; and
curing the coating on the substrate by exposing the coating to radiation or heat.

47. The method of claim 45 wherein the radiation is ultraviolet light.

48. The method of claim 46 wherein the radiation is ultraviolet light.

49. A release coated article comprising a substrate which has been coated with a silicone release coating composition of claim 1 and which has been cured by exposure to radiation or heat.

50. A release coated article comprising a substrate which has been coated with a silicone release coating composition of claim 12 and which has been cured by exposure to radiation or heat.
